(19) United States
(12) Patent Application Publication
(10) Pub. No.: US 2026/0154017 A1
(43) Pub. Date: Jun. 4, 2026

(54) PRINTER FOR SETTING POWER SUPPLY SOURCES FOR PRINT ENGINE AND EXTERNAL DEVICE

(71) Applicant: BROTHER KOGYO KABUSHIKI KAISHA, Nagoya (JP)

(72) Inventors: Tetsuya ISHIYAMA, Chita (JP); Munetoshi SOMA, Nagoya (JP); Taiki HASHIZUME, Kariya (JP); Yuki HIRAMATSU, Nukata (JP); Shuhei YAMAKAMI, Nagoya (JP)

(21) Appl. No.: 19/458,397

(22) Filed: Jan. 23, 2026

Related U.S. Application Data
(63) Continuation of application No. PCT/JP2024/025922, filed on Jul. 19, 2024.

(30) Foreign Application Priority Data
Jul. 31, 2023 (JP) 2023-124462

(51) Int. Cl. G06F 3/12; G06F 1/26

(52) U.S. Cl. CPC G06F 3/1229; G06F 1/263; G06F 1/266; G06F 3/1205; G06F 3/1221; G06F 3/1236; G06F 3/1253

(57) ABSTRACT

A controller of a printer sets one of a first power supply, a second power supply, and a combination of the first power supply and the second power supply as a supply-power source based on status information indicating a connection status between a first receiving interface and a first power supply, a connection status between a second receiving interface and a second power supply, and a connection status between a power supply circuit and an external device. The controller sets one of the first power supply, the second power supply, and the combination of the first power supply and the second power supply as a drive-power source based on the connection status information. The print engine is driven by drive-power from the drive-power source to print an image. The power supply circuit supplies supply-power from the supply-power source to the external device.

### REFERENCE TO RELATED APPLICATIONS

This is a by-pass continuation application of International Application No. PCT/JP2024/025922 filed on Jul. 19, 2024 which claims priority from Japanese Patent Application No. 2023-124462 filed on Jul. 31, 2023. The entire contents of the International Application and the priority application are incorporated herein by reference.

### BACKGROUND ART

A known portable printer is driven by a battery or an AC adapter, and selectively performs either a normal printing mode or a print speed priority mode. In the normal printing mode, the portable printer performs printing by the power from the AC adapter. In this case, the portable printer cuts off the supply of power from the battery. On the other hand, in the print speed priority mode, the portable printer performs faster printing than the normal printing mode by the power from the battery. In this case, the printer cuts off the supply of power from the AC adapter.

### SUMMARY

It is conceivable that a portable printer supplies power to an external device in conformance with the USB-PD (USB Power Delivery) standard, for example. In this case, the portable printer supplies power to the external device based on the power of either a battery or an AC adapter. Further, it is conceivable that the portable printer reduces the drive power for printing, based on the amount of power supplied to the external device. In this case, the portable printer necessitates the reduction of the print speed according to the reduced drive power. Alternatively, the supply of power to the external device may be paused during printing. In any cases, the usability of the portable printer may be decreased.

In view of the foregoing, it is an object of the present disclosure to provide a printer which can simultaneously and stably supply power to the external device and power for printing.

In order to attain the above and other objects, according to one aspect, the present disclosure provides a printer. The printer includes a first receiving interface, a second receiving interface, a print engine, a power supply circuit, and a controller. The first receiving interface is configured to be connected to a first power supply. The second receiving interface is configured to be connected to a second power supply. The power supply circuit is configured to be connected to an external device. The controller includes one or more processors. The controller is configured to perform: a setting process including: setting one of the first power supply, the second power supply, and a combination of the first power supply and the second power supply as a supply-power source based on first connection status information, second connection status information, and third connection status information, the first connection status information indicating a connection status between the first receiving interface and the first power supply, the second connection status information indicating a connection status between the second receiving interface and the second power supply, the third connection status information indicating a connection status between the power supply circuit and the external device; and setting one of the first power supply, the second power supply, and the combination of the first power supply and the second power supply as a drive-power source based on the first connection status information, the second connection status information, and the third connection status information. The print engine is configured to be driven by drive-power from the drive-power source to print an image on a sheet. The power supply circuit is configured to supply supply-power from the supply-power source to the external device.

In the above structure, the printer can secure both the supply power and the drive power by the power of the first power supply and the second power supply. Accordingly, the printer can simultaneously and stably supply power to the external device and the power intended for printing.

### BRIEF DESCRIPTION OF DRAWINGS

FIG. 1 is an illustration showing a printer 1 and a tablet PC 5 connected to each other.

FIG. 2 is a block diagram illustrating the electric configuration of the printer 1.

FIG. 3 is a flowchart illustrating a main process.

FIG. 4 is a diagram illustrating operational setting conditions for the printer 1 when an external device is not connected.

FIG. 5 is a diagram illustrating operational setting conditions for the printer 1 in a print speed priority mode.

FIG. 6 is a diagram illustrating operational setting conditions for the printer 1 in a supply power priority mode.

### DESCRIPTION

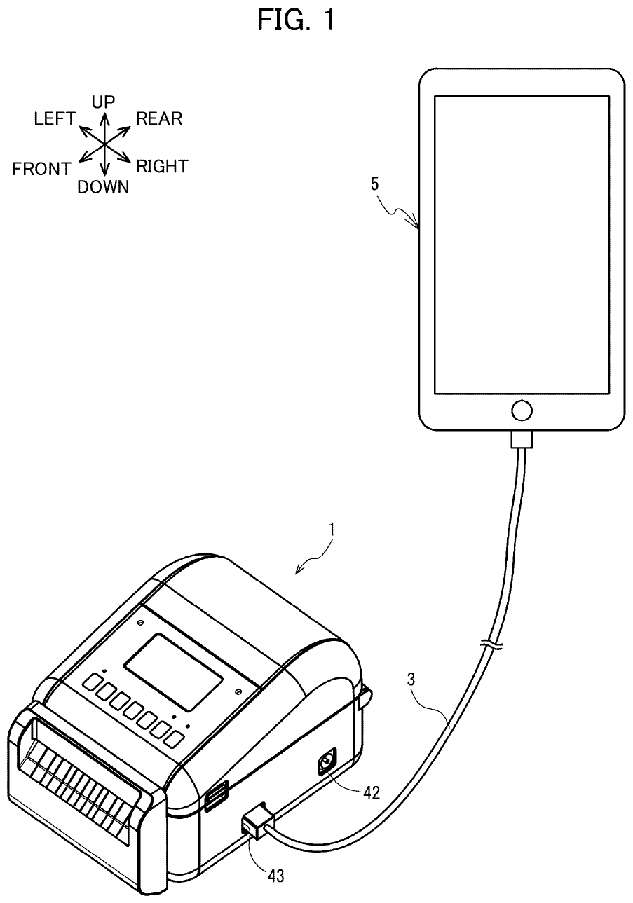

Hereinafter, an embodiment of the present disclosure will be described while referring to the accompanying drawings. The lower-right direction, upper-left direction, upper-right direction, lower-left direction, upward direction, and downward direction in FIG. 1 will be referred to as the right, left, rear, front, top, and bottom, respectively, of a printer 1.

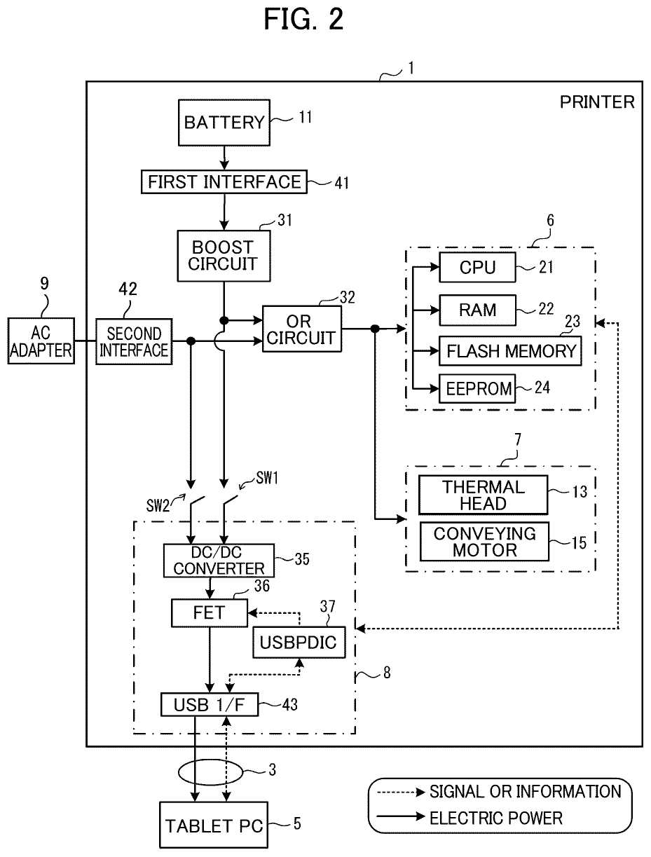

As illustrated in FIG. 1, the printer 1 is configured to be capable of printing on a print medium. The print medium includes a plurality of thermal labels continuously affixed to a long continuous sheet of backing paper, for example. The printer 1 is driven by the power supplied from a battery 11. The battery 11 is detachably mounted to a first interface 41 (see FIG. 2) positioned at the interior of the printer 1. The battery 11 is a lithium-ion battery, for example. The first interface 41 can receive power from the battery 11. The maximum power the battery 11 can output is 70 W. The printer 1 can be driven by receiving power from an external power source connected to, for example, a commercial outlet (not shown). The external power source is an AC adapter 9 (see FIG. 2), for example. The AC adapter 9 is connected to a second interface 42 positioned at the lower rear portion of the right side surface of the printer 1. The second interface 42 can receive power from the AC adapter 9. The maximum power the AC adapter 9 can output is 90 W.

An interface 43 is positioned at the lower front portion of the right side surface of the printer 1. The interface 43 is a USB interface (IF) in conformance with the USB Type-C (registered trademark) standard. “USB Type-C” is a registered trademark of USB Implementers Forum. A cable 3 is connected to the interface 43. The cable 3 includes a connector in conformance with the USB Type-C standard, and supports USB-PD (Universal Serial Bus Power Delivery). For example, the cable 3 can transmit power corresponding to a current of a maximum of 5 A, and transmit various types of information.

The printer 1 can be connected to, for example, an external device via the interface 43 and the cable 3. The external device is a tablet PC 5, for example. The tablet PC 5 includes an LCD (Liquid Crystal Display) touchscreen, for example. A user edits print data with the touchscreen. For example, objects represented in the print data such as character strings are added or modified through a user operation using the touchscreen. The tablet PC 5 transmits print data to the printer 1 via the cable 3 according to operations by the user. The printer 1 prints characters, including text and illustrations, onto the medium based on print data received from the tablet PC 5.

Additionally, the printer 1 can supply power to the tablet PC 5 in conformance with the USB-PD (USB Power Delivery) standard. Accordingly, the printer 1 can charge the tablet PC 5.

The electrical configuration of the printer 1 will be described with reference to FIG. 2. The printer 1 further includes a boost circuit 31, an OR circuit 32, a digital circuit unit 6, a print engine 7, and a power supply unit 8. The boost circuit 31 includes a power supply IC, for example. The boost circuit 31 boosts the voltage of the battery 11. The output power of the boost circuit 31 can be supplied to the OR circuit 32 and the power supply unit 8. The power of the AC adapter 9 can be supplied to the OR circuit 32 and the power supply unit 8. The supply of power to the power supply unit 8 will be described later.

The OR circuit 32 switches the power supply path to the digital circuit unit 6 and the print engine 7 depending on the connection status of the battery 11 and the AC adapter 9. When the AC adapter 9 is connected but the battery 11 is not connected, the OR circuit 32 switches the supply path so that power from the AC adapter 9 is supplied to the digital circuit unit 6 and the print engine 7. When the battery 11 is connected but the AC adapter is not connected, the OR circuit 32 switches the supply path so that power from the battery 11 is supplied to the digital circuit unit 6 and the print engine 7. When both the AC adapter 9 and the battery 11 are connected, the OR circuit 32 switches the supply path so that power from the power sources of either the AC adapter 9 or the battery 11 is supplied to the digital circuit unit 6 and the print engine 7. In other words, the OR circuit 32 can change the source of power for driving the print engine 7 (hereinafter called “drive power”) depending on the connection status of the power source. Note that the switching of the supply path by the OR circuit 32 is executed by a CPU 21, but may be set by the user.

The digital circuit unit 6 is driven by the power supplied by the OR circuit 32. The digital circuit unit 6 includes the CPU 21, a RAM 22, a flash memory 23, and a EEPROM 24. The CPU 21 performs overall control of the printer 1. The CPU 21 is electrically connected to the RAM 22, the flash memory 23, the EEPROM 24, the print engine 7, and the power supply unit 8.

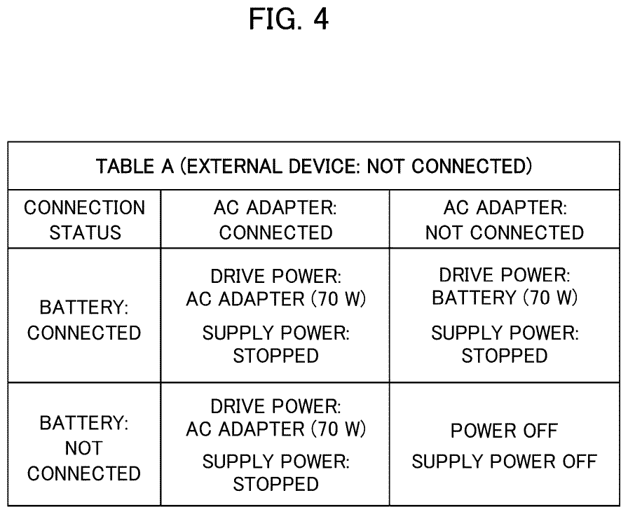

The RAM 22 temporarily stores various types of data, such as print data received from the tablet PC 5. Various programs including those to be executed by the CPU 21 for controlling the printer 1 are stored in the flash memory 23. Information such as printer settings and print history, and tables A, B, and C described later (see FIGS. 4-6) are stored in the EEPROM 24.

The print engine 7 includes a thermal head 13, and a conveying motor 15. The thermal head 13 generates heat according to a signal from the CPU 21, and performs printing onto the medium. The conveying motor 15 drives a feed roller for feeding the medium. The CPU 21 performs printing onto the medium by controlling the thermal head 13 and the conveying motor 15.

The power supply unit 8 includes a DC/DC converter 35, a USBPDIC 37, a FET 36, and the interface 43. The DC/DC converter 35 converts the input voltage from the AC adapter 9 or the battery 11 to an output voltage suitable for supplying power to the tablet PC 5 (for example, 9 V or 5 V). Furthermore, the DC/DC converter 35 can simultaneously input the input voltage of the AC adapter 9 and the battery 11. In this case, the DC/DC converter 35 can output power greater than the output voltage of each of the AC adapter 9 and the battery 11. For example, the DC/DC converter 35 can output the upper power limit, which is the upper limit of power of the USB-PD (USB Power Delivery) standard. The upper power limit is 100 W, for example. Hereinafter, the power outputted by the DC/DC converter 35 will be referred to as “supply power”. The supply power is supplied to a device such as the tablet PC 5 connected to the interface 43.

The USBPDIC 37 can communicate with the CPU 21. The USBPDIC 37 performs a negotiation in conformance with the USB-PD (USB Power Delivery) standard with the tablet PC 5 via the interface 43. The USBPDIC 37 controls the amount of supply power outputted by the DC/DC converter 35 based on the negotiation results.

The USBPDIC 37 sets the source of power to the DC/DC converter 35 by controlling switches SW1 and SW2. For example, by setting the switch SW1 to ON and setting the switch SW2 to OFF, the battery 11 is set as the source of supply power. By setting the switch SW1 to OFF and setting the switch SW2 to ON, the AC adapter 9 is set as the source of supply power. By setting both switches SW1 and SW2 to ON, both the AC adapter 9 and the battery 11 are set as the sources of supply power.

The USBPDIC 37 controls the supply of supply power from the DC/DC converter 35 to the tablet PC 5 by switching the FET 36 between ON and OFF states. For example, when the FET 36 is turned on, the supply power is supplied to the tablet PC 5 via the interface 43 and the cable 3.

A print speed priority mode and a supply power priority mode of the printer 1 will be described. The print speed priority mode is a mode prioritizing the supply of the drive power to the print engine 7 when connected to the external device via the interface 43. In this case, the printer 1 performs high-speed printing using the power of the AC adapter 9 or the battery 11. During high-speed printing, printing is performed at a maximum of 70 W of drive power, for example. High-speed printing refers to printing at a speed faster than a standard speed. High-speed printing is, for example, printing at the maximum speed which can be achieved based on the specifications of the print engine 7. The supply power priority mode is a mode prioritizing the supply of the supply power from the power supply unit 8 to the external device when the external device is connected via the interface 43. In this case, the printer 1 performs low-speed printing using the power of the AC adapter 9 or the battery 11. During low-speed printing, printing is performed at a maximum of 48 W of drive power, for example. Low-speed printing refers to printing at a speed slower than the standard speed. Low-speed printing is, for example, printing at the slowest speed which can be achieved based on the specifications of the print engine 7. Switching to each mode can be set by the user with, for example, the external device connected to the printer 1. For example, in an initial state, the print speed priority mode is set. When the external device is not connected to the power supply unit 8 of the printer 1, high-speed printing is performed since the printer 1 need not ensure the supply power to the external device. The supply power to the external device in each mode will be described later in greater detail.

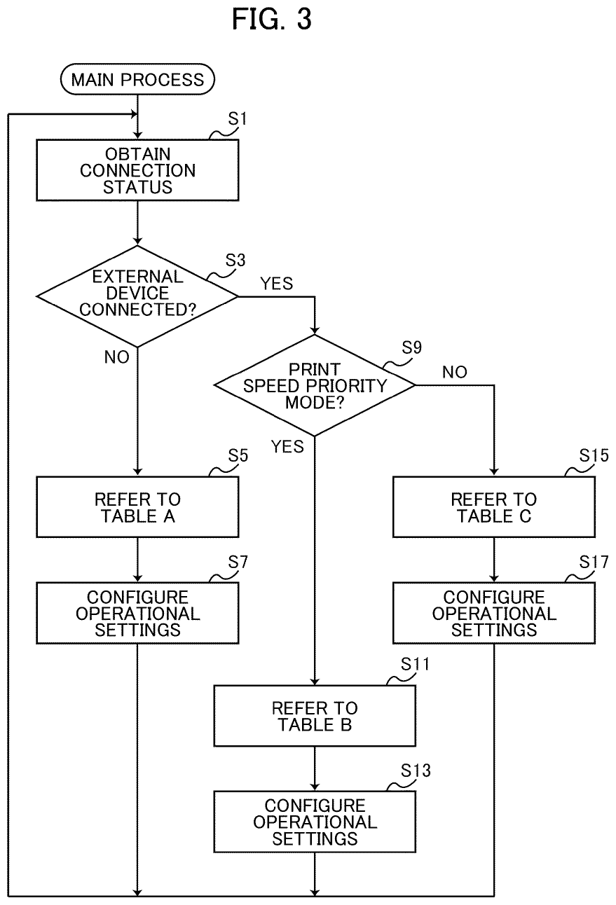

A main process will be described with reference to FIG. 3. Hereinafter, for convenience, descriptions will be given simply with regards to the supply of power to the print engine 7 and the power supply unit 8, without considering the supply of power to, for example, the digital circuit unit 6. When the power button of the printer 1 is pressed by the user, the CPU 21 executes programs read from the flash memory 23. Accordingly, the CPU 21 initiates the main process.

When the main process is initiated, in S1 the CPU 21 obtains the connection status regarding power sources. In this case, the CPU 21 identifies the connection status of the battery 11 and the AC adapter 9. Specifically, the CPU 21 identifies whether the connection status is any one of a first to third status. Here, the first status is a status in which the battery 11 is connected to the printer 1 but the AC adapter 9 is not connected to the printer 1. The second status is a status in which the AC adapter 9 is connected to the printer 1 but the battery 11 is not connected to the printer 1 to the printer 1. The third status is a status in which both the battery 11 and the AC adapter 9 are connected to the printer 1.

In S3 the CPU 21 determines whether the external device is connected to the interface 32. When the external device is determined not to be connected (S3: NO), in S5 the CPU 21 refers to table A (see FIG. 4) stored in the EEPROM 24. In S7 the CPU 21 configures the operational settings of the printer 1 based on the connection status of the power supply obtained in S1 and table A.

Here, the operational settings of the printer 1 includes, for example, setting the source of the drive power to be supplied to the print engine 7 during printing, and setting the maximum value of the drive power. When the maximum value of the drive power is 70 W, the print engine 7 can perform high-speed printing. By setting the maximum value of the drive power to 70 W that can be set for the drive power to the print engine 7, the print engine 7 can perform a process for printing images on sheets at the high speed. Here, the high speed may be a speed faster than the standard speed. Or, the high speed may be a maximum speed that the print engine 7 can achieve, that is, the maximum speed may be a maximum speed defined in the specifications of the print engine 7. In other words, the CPU 21 sets the printing speed to the high speed by setting the maximum value of the drive power to 70 W.

When the maximum value of the drive power is 48 W, the print engine 7 can perform low-speed printing. By setting the maximum value of the drive power to 48 W that is less than the maximum value of 70 W, the print engine 7 can perform a process for printing images on sheets at a low speed. Here, the low speed is slower than the high speed. The low speed is a speed slower than the standard speed in this embodiment. The low speed may be a speed slower than the maximum print speed executable by the print engine 7. In other words, the CPU 21 sets the printing speed to the low speed by setting the maximum value of the drive power to 48 W that is less than the maximum value of 70 W.

Additionally, the operational settings include setting the source of the supply power, determining whether the supply power is enabled, setting the maximum value of the supply power during printing, and setting the maximum value of the supply power during not printing. Setting the source of the supply power can be achieved by, for example, the control of the OR circuit, and the switches SW1 and SW2.

Details of the operational settings of the printer 1 depending on the connection status of the power source are stored in table A. Since the external device is not connected to the power supply unit 8, the CPU 21 does not take into consideration the power supply from the power supply unit 8 to the external device. Therefore, power supply from the power supply unit 8 is set to be disabled, regardless of the connection status of the power source.

When the second interface 42 is connected to the AC adapter 9, and the first interface 41 is connected to the battery 11, the CPU 21 sets the AC adapter 9 as the source of the drive power, and sets the maximum value of the drive power to 70 W. In this case, 70 W out of the maximum power of 90 W of the AC adapter 9 can be supplied to the print engine 7. As a result, the printer 1 can perform high-speed printing with the AC adapter 9 as the source.

When the second interface 42 is connected to the AC adapter 9, and the first interface 41 is not connected to the battery 11, the CPU 21 sets the AC adapter 9 as the source of the drive power, and sets the maximum value of the drive power to 70 W. In this case, 70 W out of the maximum power of 90 W of the AC adapter 9 can be supplied to the print engine 7. Consequently, the printer 1 can perform high-speed printing with the AC adapter 9 as the source.

When the second interface 42 is not connected to the AC adapter 9, and the first interface 41 is connected to the battery 11, the CPU 21 sets the battery 11 as the source of the drive power, and sets the maximum value of the drive power to 70 W. In this case, the entirety of the maximum power of 70 W of the battery 11 can be supplied to the print engine 7. Therefore, the printer 1 can perform high-speed printing with the battery 11 as the source.

When the operational settings of the printer 1 in S7 are complete, the CPU 21 returns to S1.

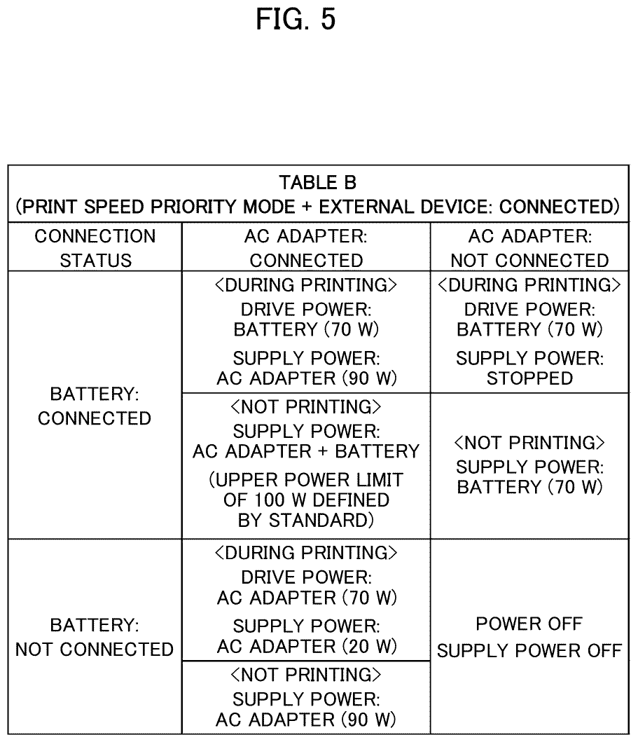

On the other hand, when the external device is determined to be connected (S3: YES), in S9 the CPU 21 determines whether the print speed priority mode is set. When the print speed priority mode is determined to be set (S9: YES), in S11 the CPU 21 refers to table B (see FIG. 5) stored in the EEPROM 24. In S13 the CPU 21 configures the operational settings of the printer 1 depending on the connection status of the power source obtained in S1 and table B.

Details of the operational settings of the printer 1 depending on the connection status of the power source are stored in table B. When the second interface 42 is connected to the AC adapter 9, and the first interface 41 is connected to the battery 11, the CPU 21 sets the battery 11 as the source of the drive power, and sets the maximum value of the drive power to 70 W. In this case, the entirety of the maximum power of 70 W of the battery 11 can be supplied to the print engine 7. As a result, the printer 1 can perform high-speed printing with the battery 11. Furthermore, the CPU 21 sets the AC adapter 9 as the source of the supply power, and sets the maximum value of the supply power to 90 W. In this case, the power supply unit 8 can supply the entirety of the maximum power of 90 W of the AC adapter 9 to the external device. When the external device requests power greater than 90 W, the power may exceed the maximum power of 90 W that the AC adapter 9 can supply if the requested power is supplied to the external device. Therefore, when the external device requests power greater than 90 W, the CPU 21 sets the power supply unit 8 so as not to supply power. On the other hand, when printing is not to be performed, the CPU 21 sets both the AC adapter 9 and the battery 11 as the sources of the supply power, and sets the maximum value of supply power to 100 W. In this case, the power supply unit 8 can supply the upper power limit of 100 W to the external device.

When the second interface 42 is connected to the AC adapter 9, and the first interface 41 is not connected to the battery 11, the CPU 21 sets the AC adapter 9 as the source of the drive power, and sets the maximum value of the drive power to 70 W. In this case, 70 W out of the maximum power of 90 W of the AC adapter 9 can be supplied to the print engine 7. Consequently, the printer 1 can perform high-speed printing with the AC adapter 9. Additionally, the CPU 21 sets the AC adapter 9 as the source of the supply power, and sets the maximum value of the supply power to 20 W. In this case, a maximum of 20 W out of the maximum power of 90 W of the AC adapter 9 can be supplied to the external device. When the external device requests power greater than 20 W, the total power outputted from the AC adapter 9 may exceed the maximum power of 90 W that can be supplied by the AC adapter 9 if the requested power is supplied to the external device. Therefore, when the external device requests power greater than 20 W, the CPU 21 sets the power supply unit 8 so as not to supply power. On the other hand, when printing is not to be performed, the CPU 21 sets the AC adapter 9 as the source of the supply power, and sets the maximum value of supply power to 90 W. In this case, a maximum of 90 W out of the maximum power of 90 W of the AC adapter 9 can be supplied to the external device. When the external device requests power greater than 90 W, the power may exceed the maximum power of 90 W that can be supplied by the AC adapter 9 if the requested power is supplied to the external device. Therefore, when the external device requests power greater than 90 W, the CPU 21 sets the power supply unit 8 so as not to supply power.

When the second interface 42 is not connected to the AC adapter 9, and the first interface 41 is connected to the battery 11, the CPU 21 sets the battery 11 as the source of the drive power, and sets the maximum value of the drive power to 70 W. In this case, the entirety of the maximum power of 70 W of the battery 11 can be supplied to the print engine 7. Therefore, the printer 1 performs high-speed printing with the battery 11. Since the entirety of the power of the battery 11 is used by the print engine 7, the CPU 21 sets the power supply unit 8 so as not to supply power. On the other hand, when printing is not to be performed, the CPU 21 sets the battery 11 as the source of the supply power, and sets the maximum value of supply power to 70 W. In this case, the entirety of the maximum power of 70 W of the battery 11 can be supplied to the external device. When the external device requests power greater than 70 W, the power may exceed the maximum power of 70 W that can be supplied by the battery 11 if the requested power is supplied to the external device. Therefore, when the external device requests power greater than 70 W, the CPU 21 sets the power supply unit 8 so as not to supply power.

When the operational settings of the printer 1 in S13 are complete, the CPU 21 returns to S1.

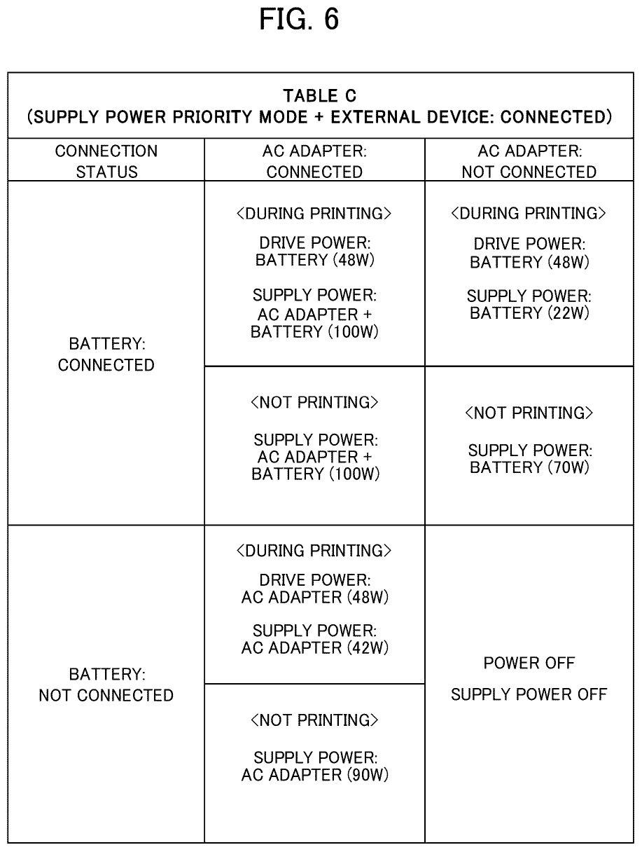

On the other hand, when the print speed priority mode is determined not to be set (S9: NO), in S15 the CPU 21 refers to table C (see FIG. 6) stored in the EEPROM 24, since the supply power priority mode is set. In S17 the CPU 21 configures the operational settings of the printer 1 depending on the connection status of the power source obtained in S1 and table C.

Details of the operational settings of the printer 1 depending on the connection status of the power source are stored in table C. When the second interface 42 is connected to the AC adapter 9, and the first interface 41 is connected to the battery 11, the CPU 21 sets the battery 11 as the source of the drive power, and sets the maximum value of the drive power to 48 W. In this case, a maximum of 48 W of the power of the battery 11 is supplied to the print engine 7. As a result, the printer 1 performs low-speed printing with the battery 11. Furthermore, the CPU 21 sets both the AC adapter 9 and the battery 11 as the sources of the supply power, and sets the maximum value of the supply power to be equal to the upper power limit of 100 W. The power supply unit 8 can supply 100 W of the supply power with the AC adapter 9 and the battery 11 being the sources. Even when printing is not to be performed, the source of the supply power and the maximum value of the supply power are set to the same settings as those set during printing.

When the second interface 42 is connected to the AC adapter 9, and the first interface 41 is not connected to the battery 11, the CPU 21 sets the AC adapter 9 as the source of the drive power, and sets the maximum value of the drive power to 48 W. In this case, a maximum of 48 W of the power of the AC adapter 9 can be supplied to the print engine 7. As a result, the printer 1 performs low-speed printing with the AC adapter 9. Additionally, the CPU 21 sets the AC adapter 9 as the source of the supply power, and sets the maximum value of the supply power as 42 W. In this case, a maximum of 42 W out of the maximum power of 90 W of the AC adapter 9 can be supplied to the external device. When the external device requests power greater than 42 W, the total power may exceed the maximum power of 90 W that can be supplied by the AC adapter 9 if the requested power is supplied to the external device. Therefore, when the external device requests power greater than 42 W, the CPU 21 sets the power supply unit 8 so as not to supply power. On the other hand, when printing is not to be performed, the CPU 21 sets the AC adapter 9 as the source of supply power, and sets the maximum value of supply power to 90 W. The entirety of the maximum power of 90 W of the AC adapter 9 can be supplied to the external device. When the external device requests power greater than 90 W, the total power may exceed the maximum power of 90 W of the AC adapter 9 if the requested power is supplied to the external device. Therefore, when the external device requests power greater than 90 W, the CPU 21 sets the power supply unit 8 so as not to supply power.

When the second interface 42 is not connected to the AC adapter 9, and the first interface 41 is connected to the battery 11, the CPU 21 sets the battery 11 as the source of the drive power, and sets the maximum power of the drive power to 48 W. In this case, a maximum of 48 W of the power of the battery 11 can be supplied to the print engine 7. Consequently, the printer 1 performs low-speed printing with the battery 11 as the source. The CPU 21 sets the battery 11 as the source of the supply power, and the upper limit of the supply power to 22 W. In this case, a maximum of 22 W out of the maximum power of 70 W of the battery 11 can be supplied to the external device. In other words, when the supply of supply power is prioritized, the CPU 21 reduces the drive power that can be supplied to the print engine 7 according to the supply power to the external device. As a result, the printing speed of the print engine 7 decreases to the speed of low-speed printing. When the external device requests power greater than 22 W, the power may exceed the maximum power of 22 W that can be supplied by the battery 11 if the requested power is supplied to the external device. Therefore, when the external device requests power greater than 22 W, the CPU 21 sets the power supply unit 8 so as not to supply power. On the other hand, when printing is not to be performed, the CPU 21 sets the battery 11 as the source of the supply power, and sets the maximum value of supply power to 70 W. In this case, the entirety of the maximum power of 70 W of the battery 11 can be supplied to the external device. When the external device requests power greater than 70 W, the power may exceed the maximum power of 70 W of the battery 11 if the requested power is supplied to the external device. Therefore, when the external device requests power greater than 70 W, the CPU 21 sets the power supply unit 8 so as not to supply power.

When the operational settings of the printer 1 in S17 are complete, the CPU 21 returns to S1.

The printer 1 performs the supplying of the drive power to the print engine 7 and the supplying of the supply power to the external device based on the conditions set in each step of the main process.

As described above, the CPU 21 sets the sources of the drive power and the supply power depending on the connection status of the first interface 41 to the battery 11, the connection status of the second interface 42 to the AC adapter 9, and the connection status of the power supply unit 8 to the external device.

The printer 1 performs power supply depending on the connection status of the power supplies and the connection status of the external device. Therefore, the printer 1 can secure both the supply power and the drive power by the power of the battery 11 and the AC adapter 9. Accordingly, the printer 1 can simultaneously and stably supply power to the external device and the power intended for printing. For example, the printer 1 can supply drive power based on the power of the battery 11 to the print engine 7, and the supply power based on the power of the AC adapter 9 to the external device. In this case, the printer 1 can, for example, print at the highest speed by making maximum use of the power of the battery 11, regardless of whether supply power is available. Therefore, the printer 1 can reduce the possibility of being subject to power restrictions even when supplying the supply power to the external device and the drive power for printing. Moreover, when the power of the battery 11 alone is available, the printer 1 can supply the drive power and the supply power based on the power of the battery 11 to each of the print engine 7 and the external device. On the other hand, when the power of the AC adapter 9 alone is available, the printer 1 can supply the drive power and the supply power based on the power of the AC adapter 9 to each of the print engine 7 and the external device. Furthermore, when the external device is not connected, the printer 1 can perform high-speed printing based on the power of either the battery 11 or the AC adapter 9. As a result, the printer 1 improves usability.

When the battery 11 is connected to the first interface 41, the AC adapter 9 is connected to the second interface 42, and the external device is connected to the power supply unit 8, the CPU 21 sets the battery 11 as the source of the drive power, and sets the AC adapter 9 as the source of the supply power. The printer 1 can perform printing with the print engine 7 by the drive power of the battery 11, and can supply power to the external device by the supply power of the AC adapter 9. Therefore, the printer 1 can perform printing by making maximum use of the power of the battery 11.

When the battery 11 is connected to the first interface 41, the external device is connected to the power supply unit 8, and the AC adapter 9 is not connected to the second interface 42, the CPU 21 sets the battery 11 as both the source of the drive power to the external device and the source of the supply power to the print engine 7. The printer 1 decreases the printing speed of the print engine 7 according to the supply power to the external device based on the power of the battery 11. As a result, the printer 1 can perform printing while securing the supply power to the external device with the battery 11 even when the AC adapter 9 is not connected to the second interface 42.

When the battery 11 is connected to the first interface 41, and the AC adapter 9 is not connected to the second interface 42, the CPU 21 sets the battery 11 as the source of the drive power to the print engine 7, regardless of whether the external device is connected to the power supply unit 8. The CPU 21 sets the print speed to maximum speed, which is the highest speed the print engine 7 can be driven by the battery 11 without supplying the supply power to the external device. When the AC adapter 9 is not connected, the printer 1 supplies the power of the battery 11 to the print engine 7 without supplying the power of the battery 11 to the external device. In this case, the printer 1 can drive the print engine 7 at maximum speed by making maximum use of the drive power based on the battery 11.

When the battery 11 is connected to the first interface 41, the AC adapter 9 is connected to the second interface 42, and the external device is connected to the power supply unit 8, the CPU 21 sets both the battery 11 and the AC adapter 9 as the sources of the supply power to the external device. The printer 1 can supply the supply power based on both the battery 11 and the AC adapter 9 to the external device. Accordingly, the printer 1 can supply a greater amount of supply power to the external device than when one of the power sources supplies the supply power.

The battery 11 and the AC adapter 9 can be connected to the printer 1. The printer 1 can efficiently use the power of the battery 11 and the AC adapter 9.

When the battery 11 is connected to the first interface 41, the AC adapter 9 is connected to the second interface 42, and the external device is not connected to the power supply unit 8, the CPU 21 sets the AC adapter 9 as the source of the drive power. By using the drive power based on the power of the AC adapter 9 for the print engine 7, the printer 1 can reduce the power consumption of the battery 11.

When the battery 11 is connected to the first interface 41, the AC adapter 9 is not connected to the second interface 42, and the external device is not connected to the power supply unit 8, the CPU 21 sets the battery 11 as the source of the drive power. When the print engine 7 is driven by the power based on the battery 11, a printing operation can be performed without using the AC adapter 9. Therefore, the user can easily carry the printer 1.

The power supply unit 8 supplies the supply power to the external device in conformance with the USB-PD (USB Power Delivery) standard. The printer 1 can perform control in conformance with the USB-PD (USB Power Delivery) standard.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The technology disclosed in the above embodiment and its variations may be combined in any ways that do not result in inconsistencies. The printer 1 utilizes a direct thermal method but is not limited to this configuration, and may employ an inkjet method. The external device is the tablet PC 5 but is not limited to this configuration. For example, the external device may be a smartphone, or other devices such as a PC.

In the above embodiment, the AC adapter 9 is used as the external power source, but is not limited to this configuration. For example, the external power source may be external batteries. The printer 1 may receive power from the external device in conformance with the USB-PD (USB Power Delivery) standard. Additionally, power may be received from an AC adapter such as the AD adapter 9 instead of the battery 11, or may be received from the external device in conformance with USB-PD (USB Power Delivery) standard instead of the battery 11. The AC adapter 9 may be connected to the first interface 41. In this case, the battery 11 may be connected to the second interface 42.

In the above embodiment, the print engine 7 can be driven by the drive power with the battery 11 or the AC adapter 9 set as the source of supply, but is not limited to this configuration. For example, the printer 1 may supply the drive power to the print engine 7 with both the battery 11 and the AC adapter 9 as the sources, in a manner similar to the method by which the DC/DC converter 35 supplies the supply power to the external device with both the battery 11 and the AC adapter 9.

In the above embodiment, the maximum power of the battery 11 and the AC adapter is 70 W and 90 W, respectively, but is not limited to this configuration. The maximum power of the battery 11 and the AC adapter 9 may be modified as appropriate. The upper power limit of the power supply unit 8 may also be modified as appropriate.

In the above embodiment, the drive power during high-speed printing and low-speed printing is 70 W and 48 W, respectively, but is not limited to this configuration. The drive power may be modified as appropriate according to the specifications of the battery 11, the AC adapter 9, and the print engine 7. The upper power limit may also be modified from 100 W, as appropriate.

In the above embodiment, when the external device requests power greater than the supply power that can be supplied, the CPU 21 sets the power supply unit 8 so as not to supply power, but is not limited to this configuration. For example, in a case where an excess of power which can be supplied is available, the excess power may be supplied to the external device as the supply power.

The USB PDIC 37, an ASIC, and an FPGA (Field Programmable Gate Array) may be used instead of the CPU 21 as a processor. The term “processor” encompasses both a single processor or a group of multiple processors located either locally or remotely working together or in a distributed fashion to collectively perform the tasks attributed to the “processor” described herein. One or more processors may be referred to as a controller. Each of the steps in the main process may be executed through distributed processing performed by a plurality of processors. The printer 1 may include other non-transitory storage mediums, such as a hard disk drive. The non-transitory storage mediums may be any storage medium capable of storing information regardless of the period for which the information is stored. The non-transitory storage mediums may not include transitory storage media (conveyed signals, for example).

The various programs may be downloaded from a server connected to a network (not shown), i.e., transmitted as transmission signals, and may be stored in memories such as a hard disk drive, for example. In this case, the various programs may be stored in a non-transitory storage medium, such as a hard disk drive included in the server.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

In the foregoing description, the battery 11 is an example of the first power source of the present disclosure. The first interface 41 is an example of the first power receiving interface of the present disclosure. The AC adapter 9 is an example of the second power source of the present disclosure. The second interface 42 is an example of the second power receiving interface of the present disclosure. The CPU 21 is an example of the controller of the present disclosure. Steps S7, S13, and S17 executed by the CPU 21 are each an example of the setting process of the present disclosure. The step S17 executed by the CPU 21 is an example of the first speed setting process of the present disclosure. The step S13 executed by the CPU 21 is an example of the second speed setting process of the present disclosure.

What is claimed is:

1. A printer comprising:
a first receiving interface configured to be connected to a first power supply;
a second receiving interface configured to be connected to a second power supply;
a print engine;
a power supply circuit configured to be connected to an external device; and
a controller including one or more processors, the controller being configured to perform:
a setting process including:
setting one of the first power supply, the second power supply, and a combination of the first power supply and the second power supply as a supply-power source based on first connection status information, second connection status information, and third connection status information, the first connection status information indicating a connection status between the first receiving interface and the first power supply, the second connection status information indicating a connection status between the second receiving interface and the second power supply, the third connection status information indicating a connection status between the power supply circuit and the external device; and
setting one of the first power supply, the second power supply, and the combination of the first power supply and the second power supply as a drive-power source based on the first connection status information, the second connection status information, and the third connection status information,
wherein the print engine is configured to be driven by drive-power from the drive-power source to print an image on a sheet,
wherein the power supply circuit is configured to supply supply-power from the supply-power source to the external device.

2. The printer according to claim 1,
wherein when the first receiving interface is connected to the first power supply, the second receiving interface is connected to the second power supply, and the power supply circuit is connected to the external device,
the first power supply is set as the drive-power source and the second power supply is set as the supply-power source.

3. The printer according to claim 1,
wherein the controller is configured to further perform:
a printing speed setting process including:
setting a print speed for the print engine to print the image on the sheet,
wherein when the first receiving interface is connected to the first power supply, the second receiving interface is not connected to the second power supply, and the power supply circuit is connected to the external device,
the first power supply is set as both the drive-power source and the supply-power source, and
the print speed is set to decrease based on increase of the supply-power.

4. The printer according to claim 1,
wherein the controller is configured to further perform:
a printing speed setting process including:
setting a print speed for the print engine to print the image on the sheet,
wherein when the first receiving interface is connected to the first power supply, and the second receiving interface is not connected to the second power supply,
the first power supply is set as the drive-power source, regardless of whether the power supply circuit is connected to the external device,
the print speed is set to a maximum print speed executable by the print engine, and
the supply-power is not supplied to the external device during printing of the image on the sheet at the maximum print speed.

5. The printer according to claim 1,
wherein when the first receiving interface is connected to the first power supply, the second receiving interface is connected to the second power supply, and the power supply circuit is connected to the external device,
the combination of the first power supply and the second power supply is set as the supply-power source.

6. The printer according to claim 2,
wherein the first power supply is a battery,
wherein the second power supply is an alternating current (AC) adapter.

7. The printer according to claim 6,
wherein when the first receiving interface is connected to the battery, the second receiving interface is connected to the AC adapter, and the power supply circuit is not connected to the external device,
the AC adapter is set as the drive-power source.

8. The printer according to claim 1,
wherein the first power supply is a battery,
wherein the second power supply is an alternating current (AC) adapter,
wherein when the first receiving interface is connected to the battery, the second receiving interface is not connected to the AC adapter, and the power supply circuit is not connected to the external device,
the battery is set as the drive-power source.

9. The printer according to claim 1,
wherein the power supply circuit supplies the supply-power to the external device in conformance with the Universal Serial Bus Power Delivery standard.
